(19) United States
(12) Patent Application Publication
(10) Pub. No.: US 2018/0155086 A1
(43) Pub. Date: Jun. 7, 2018

(54) Center Folded Bottom Self Opening Style Bag and Method of Manufacture

(71) Applicant: Gateway Packaging Company, White House, TN (US)

(72) Inventors: Robert Tiepelman, High Ridge, MO (US); Omar Abuaita, Nashville, TN (US); Brian Schiermeier, Florissant, MO (US); Mark Schnell, Kimberly, WI (US)

(73) Assignee: Gateway Packaging Company, White House, TN (US)

(21) Appl. No.: 15/726,814

(22) Filed: Oct. 6, 2017

Related U.S. Application Data
(60) Provisional application No. 62/405,414, filed on Oct. 7, 2016.

(51) Int. Cl. B65D 30/20; B65D 30/08; B65D 30/18; B31B 70/26

(52) U.S. Cl. CPC B65D 31/10; B65D 31/02; B31B 2160/20; B65D 31/04; B31B 70/26; B65D 31/08

(57) ABSTRACT

A method of manufacturing an SOS bag of indefinite length is disclosed including, as a preliminary step, providing a gusseted tube of indefinite length. In a series of steps, the gusseted tube may be cut, folded, and sealed to create a unique bottom for an SOS bag. The bottom of the tube includes a center flap flanked by two bottom flaps, where the center flap may be heat sealed onto a bottom flap. The disclosure additionally includes bags manufactured by the method disclosed herein, as well as SOS bags having the unique construction disclosed herein.

### PRIORITY CLAIM

This application claims priority to co-pending U.S. provisional patent application 62/405,414, filed on Oct. 7, 2016.

### FIELD OF DISCLOSURE

A new gusseted self-opening style bag with a unique bottom construction is disclosed, the bag manufactured via a new manufacturing process.

### BACKGROUND

The statements in this section merely provide background information related to the disclosure and do not necessarily all constitute prior art.

The prior art includes a bag known as an SOS bag. Opinions differ on what SOS abbreviates, though it is commonly considered an abbreviation of Self Opening Style. Other interpretations of SOS include Self Opening Sack, Self Opening Square, and Self Opening Satchel. Regardless, an SOS bag as described herein is generally understood to be a gusseted bag including front and back panels joined by gussets, where the bag may be opened from a flat folded orientation to reveal a substantially flat rectangular bottom. When the bag is opened, the gussets may be unfolded and serve as side walls that, in conjunction with the front and back panels of the bag, as well as the rectangular bottom, define the general structure of the bag. A ubiquitous SOS bag of the prior art might include, by way of illustrative example, a simple single-layer brown paper lunch sack.

In the packaging industry, it is common for the top of the SOS bag to be filled with consumer goods, followed by the closure of the top of the bag to contain the goods. This closure can be done in a variety of manners, including applying adhesive or other seal to the top of the bag and rolling the bag closed to complete a top seal of the bag. In other applications, a reclosure apparatus, such as a resealable zipper profile with complementary interlocking features or a hook and loop type reclosure mechanism, for example, may be mounted atop the bag. In other applications, a heat or ultrasonic seal could be applied across the top of the bag.

Rectangular bottom, gusseted bags made substantially of plastic material exist in the art, though those bags are substantially distinct from the bags of this disclosure, specifically in that they are not traditional SOS bags. For example, some rectangular bottom gusseted bags of the prior art, such as those manufactured on box pouch machines, are not made from a gusseted tube. Rather, they are from one or more webs of material that are folded and sealed together into the general shape of a bag. These prior art bags are folded, heat sealed, and then trimmed to give flush edges around the folds and seams of the gussets, side walls, and bottoms, creating substantial waste. One of skill in the art will appreciate the numerous distinctions between a pouch-style bag and a bag that will be disclosed herein.

### SUMMARY

This section provides a general summary of the disclosure, and is not intended to provide a comprehensive disclosure of its full scope or all of its features.

This disclosure includes method of manufacturing a new SOS bag including, as a preliminary step, providing a gusseted tube of indefinite length. In a series of steps, the gusseted tube may be cut, folded, and sealed to create a unique bottom for an SOS bag. The bottom of the tube may be manipulated into a lowercase t shape when viewed from a profile and then made to undergo a series of folding and heat sealing to create the bag of the disclosure. Other sealing mechanisms and a variety of bag material constructions are disclosed.

The disclosure additionally includes bags manufactured by the method disclosed herein, as well as SOS bags having the unique construction disclosed herein.

### BRIEF DESCRIPTION OF THE FIGURES

The drawings described herein are for illustrative purposes only of selected embodiments and not all possible implementations, and are not intended to limit the scope of the present disclosure.

FIG. 1, which shows prior art, is a perspective view of a conventional SOS bag, this bag open and resting upright on its bottom.

FIG. 2, which also shows prior art, is a view of the conventional SOS bag of FIG. 1, this particular view showing the bag folded and laying down, with the bottom of the bag visible.

FIG. 3 shows an embodiment of the creation of the gusseted tube of material into which a bag of the disclosure will be made, this figure showing an embodiment of sealing of the overlap of the bag panel.

FIG. 4 shows an embodiment of a gusseted tube of material of an indefinite length.

FIG. 5 shows an embodiment of a die cut layout of an unfolded bag of the disclosure, this layout showing a step cut top.

FIG. 6 shows an embodiment of a die cut layout of an unfolded bag of the disclosure, this layout showing a Z cut top.

FIG. 7 shows an elevated perspective view of the gusseted tube of FIG. 4, having undergone a folding step whereby the gussets and panels of the tube have been folded to create a lowercase t shape to create a center flap.

FIG. 8 shows a profile view of the gusseted tube of FIG. 7, this figure highlighting the fold patterns on the bottom end of the tube, where the gussets have been fully opened to a substantially planar position.

FIG. 9 shows an embodiment of a step in the process of creating the folded gusseted tube of FIG. 7, where the gusseted tube is substantially flat and an indication of a direction of folding is shown.

FIG. 10 shows an embodiment of the result of the step of folding seen in FIG. 9, where the bottom of the gusseted tube has been folded to achieve the lowercase t shape of FIG. 7, while the tube remains substantially flat.

FIG. 11 shows a top down view of the folded gusseted tube of FIG. 7, with details on a pair of heat seals.

FIG. 12 shows a partial view of an embodiment of an ultrasonic welding station prepared to apply heat seals to the center flap of the gusseted tube of FIG. 11.

FIG. 13 shows a partial profile view of an embodiment of the ultrasonic welding station seen in FIG. 12 applying heat seals to the center flap of the gusseted tube of FIG. 11.

FIG. 14 shows an elevated perspective view of a hot air heat sealing station applying a heat seal to the center flap of the gusseted tube, having undergone the ultrasonic welding of FIG. 12.

FIG. 15 shows an embodiment of a completed bottom of the SOS bag of the disclosure.

FIG. 16 shows an embodiment of a series of completed bags of the disclosure as displayed on retail shelving for viewing by consumers.

Corresponding reference numerals indicate corresponding parts throughout the several views of the drawings.

### DETAILED DESCRIPTION

The following description of various embodiments is merely exemplary in nature and is in no way intended to limit the invention, its application, or its uses. Areas of applicability will become apparent from the description provided herein.

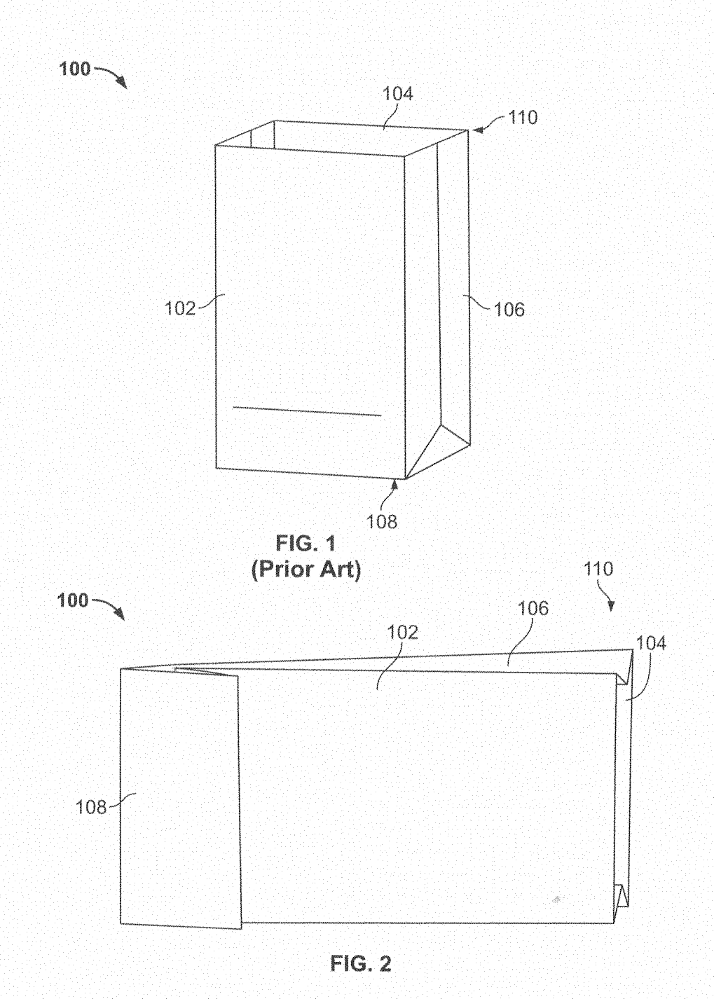

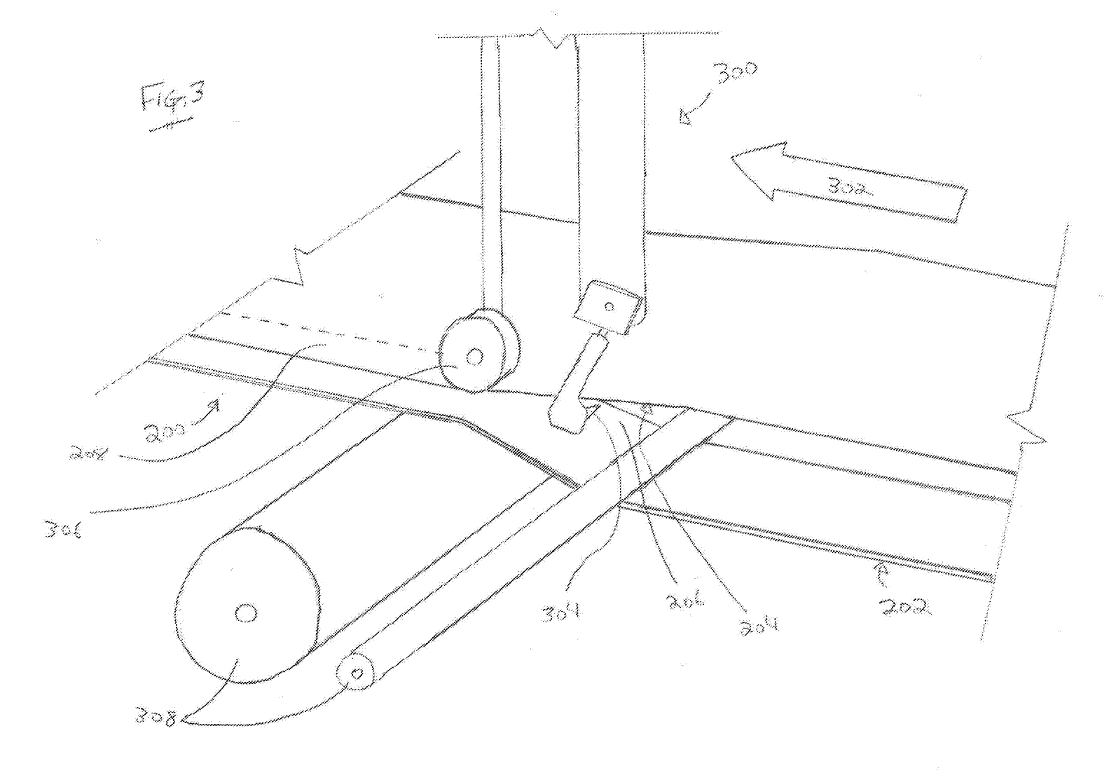

A new SOS bag with a unique bottom closure, as well as a method of making the same, is disclosed. A typical SOS bag 100, as seen in FIG. 1, includes a front panel 102, a back panel 104, and two gusseted side panels 106 joining the front and back panels, to create a tube having an inside and an outside. A length of tube may be folded and sealed at one end to create a bottom 108, thereby forming an SOS bag. The unfolded, open end of the tube may be referred to as the top 110 of the bag or the open end of the bag. The SOS bag of FIG. 1 is unfolded and opened upright, while the SOS bag of FIG. 2 is folded substantially flat. A bag of the disclosure will resemble the prior art SOS bag of FIGS. 1 and 2, with the distinction that the bottom of the bag of the disclosure includes a unique construction manufactured via a unique method, as will now be explained.

A bag of the disclosure may be constructed from a gusseted tube of material of indefinite length.

The tube, and hence the bag, may be constructed of a variety of materials, including but not limited to a multi-layer construction. A multi-layer construction, for example, may include plastic film on the inner-most layer on the inside of the bag. Other layers may include printed paper, such as printed clay coated paper, one or more additional film layers, including an exterior film layer, a kraft paper layer, and a variety of other layers of material. Various other layers known to those of skill in the art of construction of multi-layered bags may be implemented to make a bag as disclosed herein.

Where the multi-layer construction includes an inner plastic film layer and a middle paper layer, those layers may be adhered together via a hot melt adhesive. Where the multi-layer construction includes an outer plastic film layer and a middle paper layer, those layers may also be adhered together via a hot melt adhesive. Where the SOS bag is multi-layered, the layers may themselves be adhered together in a variety of manners, including a flood coat of hot melt adhesive between the layers.

In an embodiment, a film layer may be adhered to any adjacent layer via laminating the film to said layer. For example, an inner plastic film layer may be laminated to a middle clay coated paper layer, and an outer film layer may be laminated to said middle clay coated paper layer.

The tube may, in an embodiment, be a single layer of plastic material, or alternatively a web of multi-layered plastic may be laminated together to form an effectively single ply such that the individual layers are not distinguishable or separately manipulable. This is distinct from the, for example, multi-layered construction that includes an inner plastic film layer, a middle kraft paper layer, and an outer printed clay coated paper layer, where each of those layers is still recognizable and distinct, and might be at least partially independently manipulated via bag manufacturing machinery.

In an embodiment of an effectively single ply plastic laminate, an inner layer of woven oriented polypropylene may be laminated to an outer layer of reverse printed oriented polypropylene to make an effectively single layer web of material. Reverse-printed is understood to mean a substantially transparent or translucent plastic film that has been printed with backwards text and/or imagery that is visible through the plastic film such that the text and/or imagery is legible, i.e. not backwards, when viewed from the side of the film opposite from where it has been printed. Alternatively, an inner non-woven plastic film layer and an outer reverse printed plastic layer may be laminated together to form an effectively single layer web of material. Additionally, a single ply of plastic film may be used to make a bag as disclosed herein.

These non-limiting examples and others are fully embraced by the scope of this disclosure as the construction material into which a bag of the disclosure is made by the methods disclosed herein.

The gusseted tube of indefinite length into which a bag of the disclosure may be made can be created in a variety of ways. In an embodiment, a substantially continuous sheet of material having a consistent width and an indefinite length may be fed along a machine and by its length and manipulated and folded onto itself across its width to create an overlap of material. At the overlap, the material may be sealed to itself to create a tube of material. This folding may include folding to create gussets that run the length of the material to create the gusseted tube, where the folding of the gussets may happen before, after, or in substantial synchronization with the sealing of the material.

Where the sheet of material is fed along a machine, the material may be fed, for example, from a spool of material, or from an apparatus that creates plastic sheeting from raw plastic materials such as pellets. Or, in another embodiment, the material may be fed from a series of spools and laminated together to turn a multi-layer construction into an effectively single layer construction.

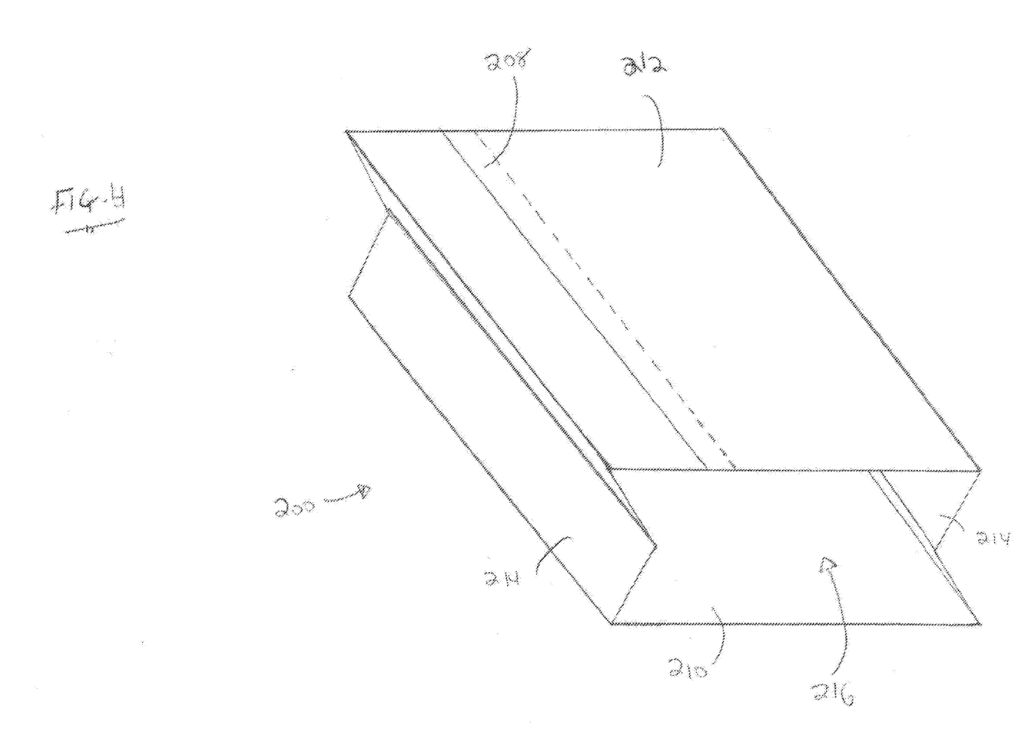

FIG. 3 shows an example of a method of creating a gusseted tube 200. Specifically, FIG. 3 shows a portion of material that has been folded to create gussets 202 as well as a heat sealing apparatus 300 operating on a machine where the tube is moving in a first direction 302 relative to the stationary heat sealing apparatus. In this embodiment, the seal is being created by selective application of hot air via a nozzle 304 onto an inner edge 204 of the material as the tube 200 moves in the first direction 302. As the tube continues along the machine in the first direction, the now at least slightly molten plastic material that comprises the inner edge 204 of the material is pressed against a corresponding outer edge of material 206 to provide compression and thereby adhere the two edges together and create an overlap 208, which may be referred to as a side seam. The pressing may be effected by, for example, a roller 306 in close proximity to a hot air nozzle. The tube may be manipulated in this method via various subsequent rollers 308 known in the art of bag manufacturing. In this way, the tube 200 may be completed, and the side seam 208 runs the length of the tube and is substantially parallel to the folds that define the front and back panels and the gussets. It should be noted that the selective hot air is applied in this embodiment to the inner edge of the overlapping material and not to the outer edge of material being overlapped, as the outer edge in this example is adjacent to the flat folded gussets. If the hot air was to be applied to the outer edge, being adjacent to the flat folded gussets, then, depending on various factors including the construction of the material and the geometry of the gussets relative to the side seam, the manufacturer runs the risk of undesirably heat sealing the gussets, resulting in a non-functional gusset and bag.

In an alternative embodiment, the material may be cut into planar segments of material of substantially equal lengths and then folded and sealed along an overlap to create side seams as individual tube portions, as opposed to being sealed along an overlap in a sheet of indefinite length which is then separated into individual tube segments.

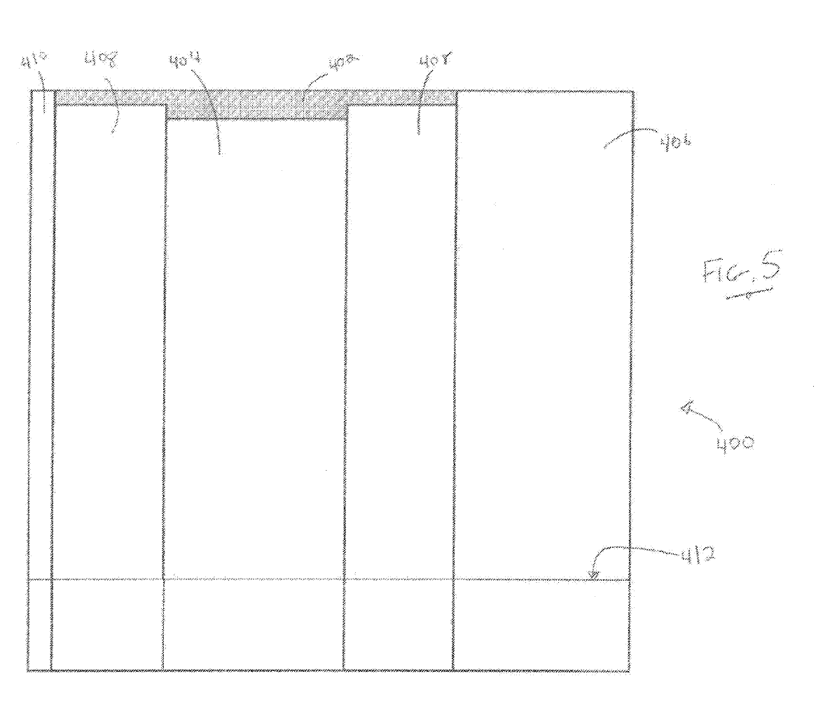

FIG. 4 shows an embodiment of a gusseted tube 200 of indefinite length that may be used to create a bag of the disclosure, this figure including detail of an embodiment of a side seam 208, including a side seam created via the aforementioned selectively applied hot air sealing method.

Although hot air sealing has been described, other sealing mechanisms may be used at various points of the manufacture of the bag of the disclosure. For example, ultrasonic sealing, also known as ultrasonic welding, is a method of applying high-frequency ultrasonic acoustic vibrations to a substrate to create a solid-state weld between two surfaces. This can be done selectively via an ultrasonic horn in combination with an anvil and wheel as the substrate moves in a lateral direction past the ultrasonic welding station. In another embodiment, a conventional heat bar may be used in some instances. A heat bar may be a heated element, often in the shape of a linear mass, a bar, to apply heat directly to a surface, thereby causing a brief molten state to a plastic material. In either instance, pressure in the form of, for example, a rolling mechanism could be used to press two surfaces together when one or more has received a sealing application to provide a snug seal between the surfaces. In another embodiment, a hot melt adhesive may be used to seal two surfaces, where a hot melt is an adhesive applied between surfaces that may then be pressed together. These and other mechanisms known in the art for sealing two surfaces of material are embraced by this disclosure.

Bags of the disclosure are manufactured in part via a new bottom closure process that will be described hereinafter. However, the top of the bag may vary based upon the desires of the bag customer. The bag customer may be a dog food manufacturer, for example, who might want the top of the bag in one type of configuration or another. A flush cut bag is understood to mean a bag where the upper edges of the bag are substantially flush. In a flush cut bag, where the SOS bag is open and resting with the bottom of the bag on a horizontal surface, the upper edges of the bag generally define a horizontal plane parallel to the bottom of the bag. A step cut bag, by comparison, includes a first panel of a first height, gussets of a second height slightly shorter than the first panel height, and a second panel of a third height, slightly shorter than the gusset height. A Z cut bag, includes a first panel of a first height and a second panel of a second height, where the transition between the two panels along the gussets is a single diagonal cut that, when the tube and gussets are folded flat, resembles a Z or backwards Z, depending on which gusset is being viewed. Flush cut, step cut, and Z cut are all known terms to those of ordinary skill in the art with respect to gusseted bags. These and other tops, including those suitable for accepting various closure and reclosure apparatuses, are all embraced by this disclosure.

The gusseted tube of FIG. 4 includes a front panel 210 and a back panel 212, joined by two gussets 214, the tube having an interior cavity 216. Although in this figure a front and back have been assigned such that the seam is on the back panel, this disclosure is not intended to be so limiting.

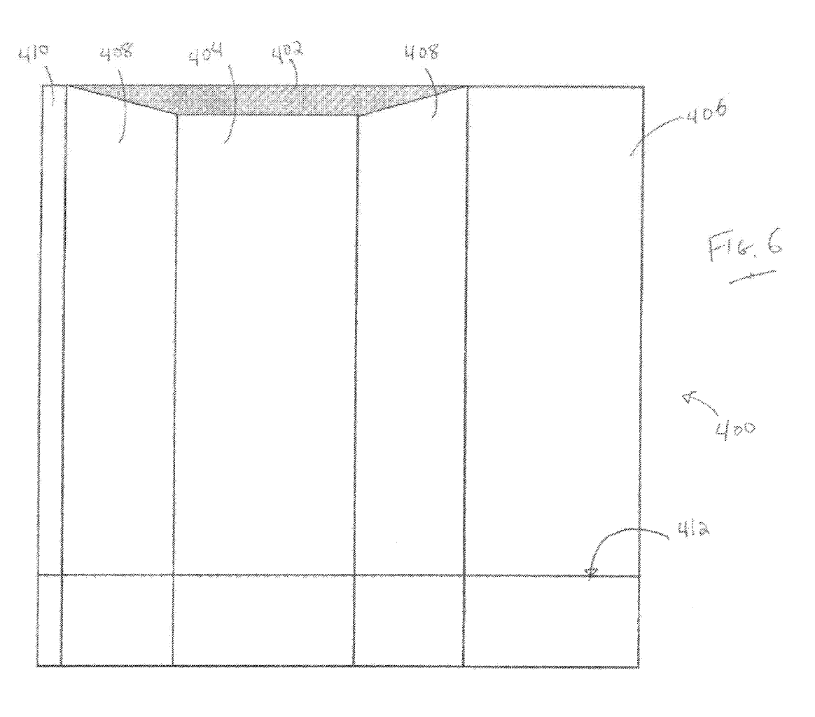

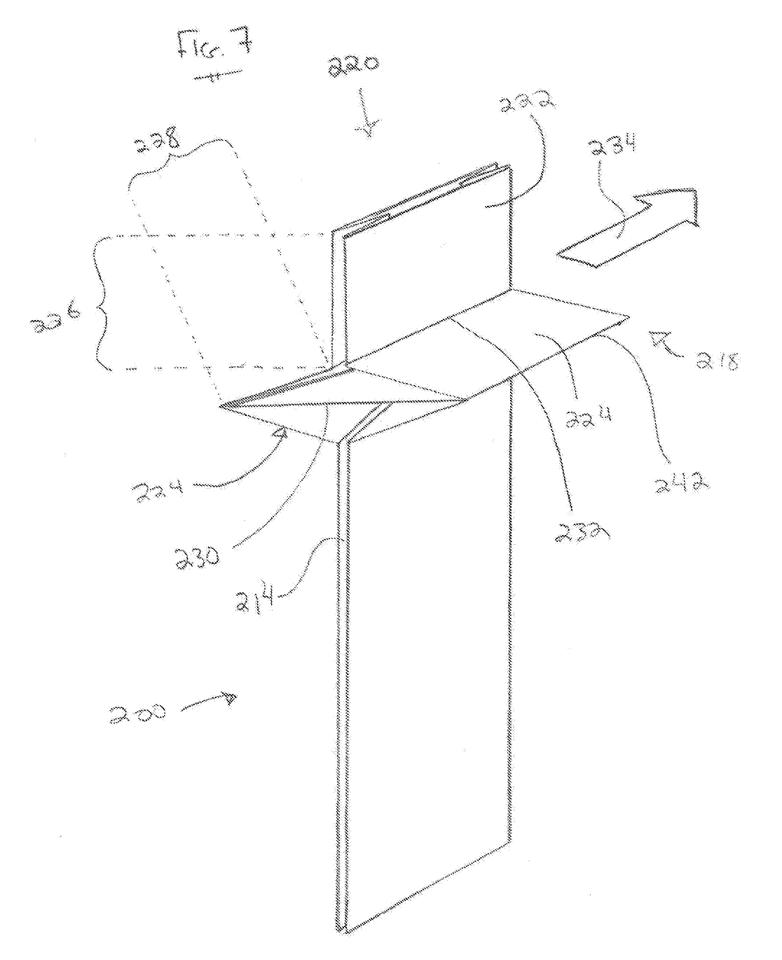

FIG. 5 shows a step cut die cut pattern suitable for use in manufacturing a bag of the disclosure, and FIG. 6 shows a Z cut pattern suitable for use in manufacturing a bag of the disclosure. Where die cutting of the top of the bag is desirable, in an embodiment the die cutting of the material occurs before the folding and sealing of the material into the gusseted tube of indefinite length. In this way, where a step cut or Z cut is to be on the final product bags, the gusseted tube of indefinite length will include a series of equally spaced apart die cuts corresponding to the unfolded die cut patterns of FIGS. 5 and 6. Alternatively, the die cutting of the tops of the bags may occur after each gusseted tube is cut into individual segments. In another embodiment, the die cutting may occur before the creation of the gusseted tube, at intermittent distances on a continuous length of material. In yet another embodiment, the die cutting may occur before the creation of a gusseted tube on individual panels of material that may then be formed into gusseted tubes.

It should be understood that die cutting of the patterns seen in FIGS. 5 and 6 is not intended to be limited strictly to literally die cutting of the material. Indeed, all cutting or other mechanisms for separation of the grayed areas shown in FIGS. 5 and 6, and cutting to produce other tops of bags, are embraced by this disclosure. Further, the dimensions and ratios seen in FIGS. 5 and 6 are not meant to be so limiting, as these figures are embodiments intended to show various configurations of the top of the bag. A bag of the disclosure may have any suitable width, length, height, etc. and still be embraced by the claims.

Specifically, in FIGS. 5 and 6, an area of material 400 into which a bag of the disclosure will be formed may receive one or more cuts to create a section of material to be removed 404 to generate the specific respective cut of the top of the eventual SOS bag. These figures additionally show fold lines that will eventually define the future front panel 404, the future back panel 406, and future gussets 408 of the bag. A region of future overlapping section 410 is also present, as seen in FIG. 3, which will include a portion of overlapping that results in the side seam that will define the gusseted tube of the disclosure. A future bottom fold line 412 that defines portions of the material that will eventually make the bottom of the bag runs the width of the area of material 400 is also shown in FIGS. 5 and 6.

Gusseted tubes as described herein include a bottom end that undergoes manipulations and sealings to create the bag of the disclosure, where the top end of the tube is the location that the cut pattern of FIG. 5 or 6, when applicable, would reside. The bags may be cut into segments of gusseted tubes which will then be manipulated and sealed to create the SOS bag of the disclosure. Where a flush cut is desired, cutting of the tube of indefinite length into individual segments will create the flush top of the bag. Where heat seals are used, as opposed to seals effected via glue or hot melt adhesive, a plastic-to-plastic bond may be used, where one plastic film or layer would be bonded to an adjacent plastic film or layer.

An exemplary method of manufacturing a bag of the disclosure will now be described. In a preliminary step, a section of gusseted material as previously described herein is provided.

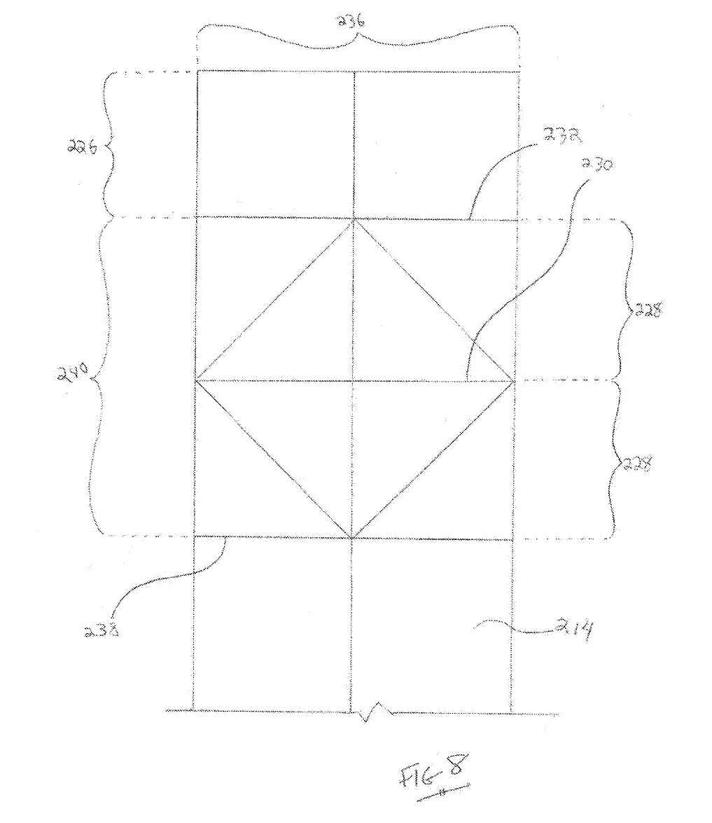

Turning further to the figures, FIG. 7 the gusseted tube 200 of FIG. 4 has undergone, in a first step of the process, a folding at the bottom of the tube 218 to create a lowercase t shaped gusseted tube 220, where the tube resembles a cross or lowercase t when viewed in profile from a gusset side of the tube. The result of this folding first step is the creation of a center flap 222 and two bottom flaps 224. The tube of FIG. 7 is inverted, so that the bottom is up, as it may be presented to sealing stations. The length 226 of the center flap in this embodiment is slightly less than the lengths 228 of the bottom flaps. The gusset 214 has been folded in this first step to create a gusset fold line 230. The center flap 222 is distinguished from the two bottom flaps 224 by a center flap fold line 232 Also indicated in FIG. 7 is a first sealing direction 234, which in an embodiment is the direction of movement of the tube towards and into sealing stations where the bag manufacturing process may continue. Each bottom flap includes an outer edge 242 that runs the width of the tube and will define a portion of the perimeter of the bottom of the bag of the disclosure. The gusset fold line 230 is a portion of folded gusset that runs from the outer edges 242 across the side of the tube, on both sides of the tube.

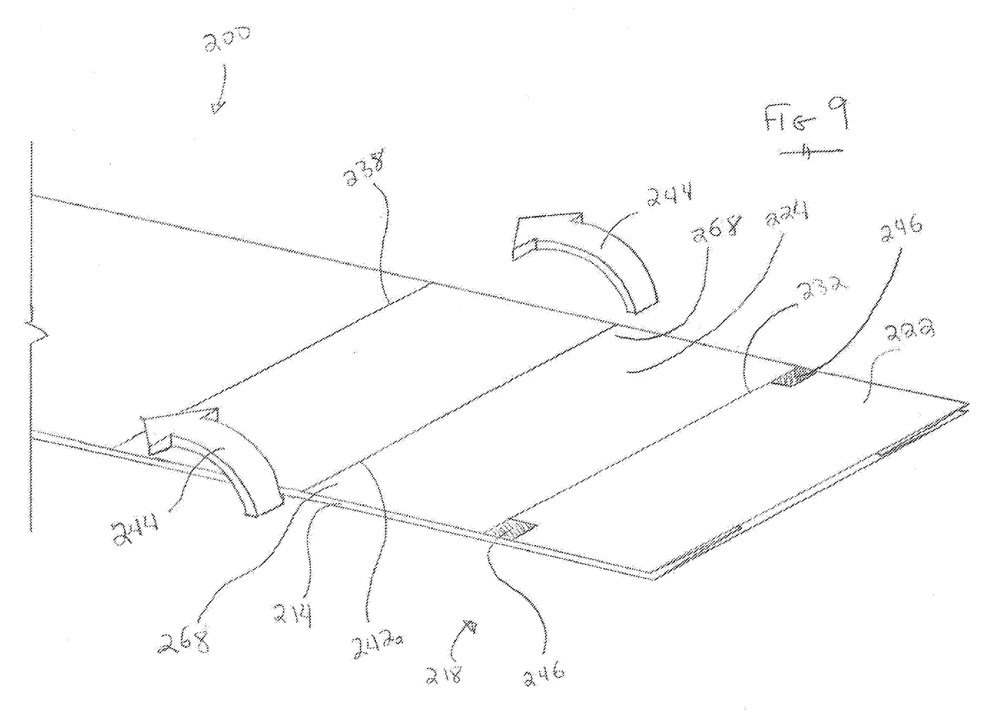

To achieve the lowercase t shaped tube 220 of FIG. 7, the folding first step must occur. Turning to FIG. 8, a profile view of the gusseted tube of FIG. 7 is shown, this figure highlighting the fold patterns on the bottom end of the tube 220, where a gusset 214 has been fully opened to a substantially planar position. The center flap fold line 232 and gusset fold line 230 are visible, as is a bottom flap fold line 238, which is the line about which the folding of the tube will take place in this first step, and which differentiates the bottom flaps 224 from the rest of the body of the tube 200 when the tube is in the lowercase t configuration 220 of FIG. 7. The length 226 of the center flap is slightly less than the length 228 of the bottom flaps. Additionally, the width 236 of the bag when fully opened is in this embodiment twice the length 228 of the bottom flaps. Similarly, the distance 240 between the center flap fold line 232 and the bottom flap fold line 238 before the folding of the tube into the configuration of FIG. 7 is substantially the same as the width 236 of the bag.

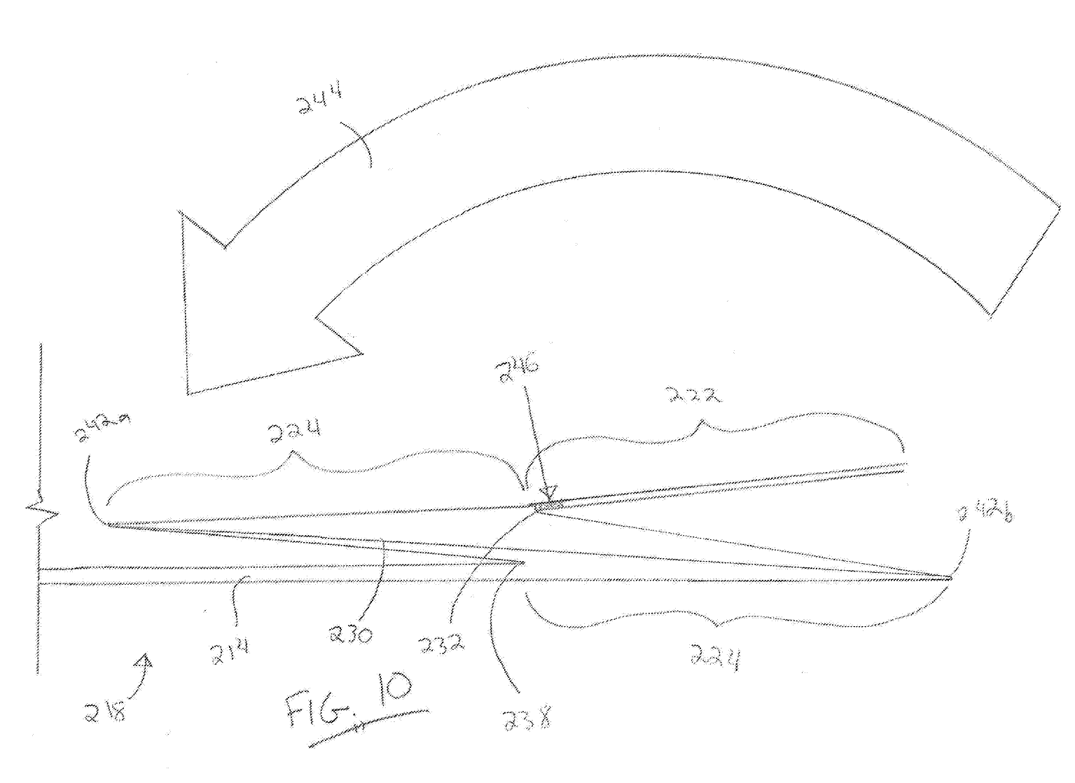

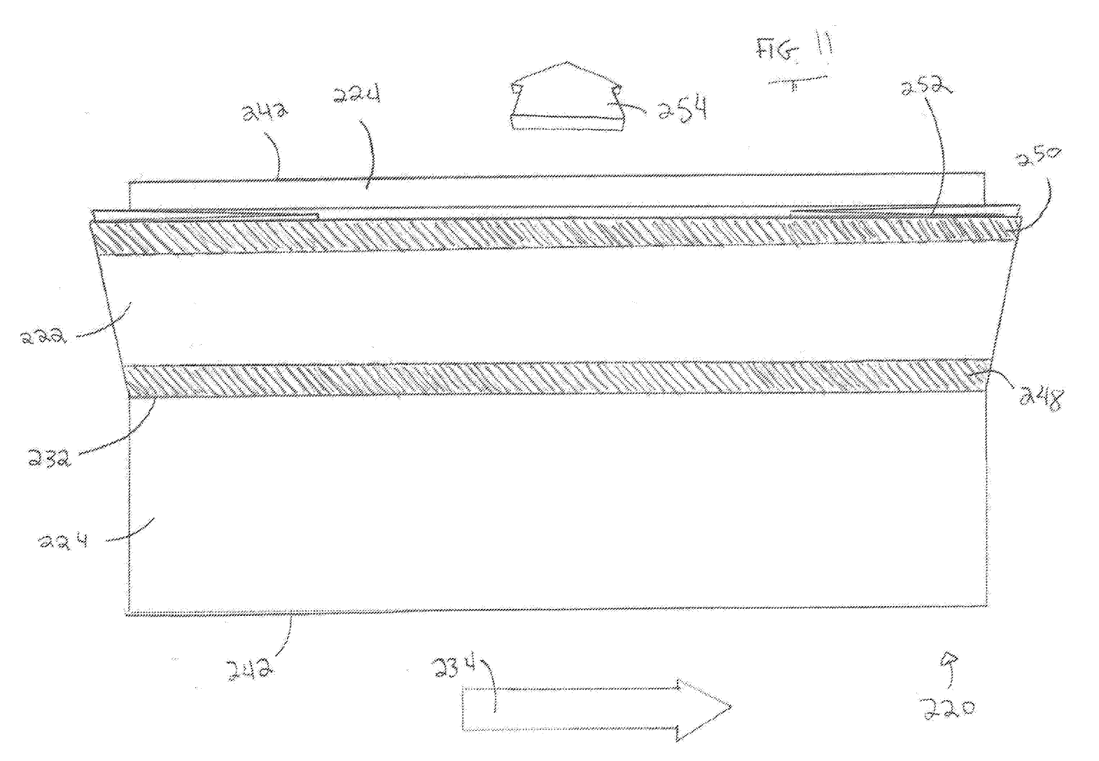

FIG. 9 shows an embodiment of a the first step of the process, specifically creating the folded gusseted tube of FIG. 7, where the bottom 218 of the tube 200 can be seen. Here the gusseted tube is substantially flat and an indication of a direction of folding 244 is shown. It may be necessary to apply a pair of tack welds 246 on the center flap 222 adjacent to the center flap fold line 232, near the outer edges of the tube and gussets, before this first step. These tack welds are seen as areas of hashed lines in FIG. 9. In an embodiment of the first step, one may grasp the tube by areas 268 near the outer edge 242a of one bottom flap 224 while the tube 200 is in the flat position of FIG. 9 and pull the portion of the tube at the outer edge 242a of that bottom flap in the folding direction 244 over and about the bottom flap fold line 238. In this way, in conjunction with the tack welds 246, the folded tube of FIG. 10 may be created. This folding may be done manually or mechanically, and this particular folding method is a non-limiting example of achieving the folded gusseted tube shown in FIG. 7.

The tack welds 246 of FIG. 9 may be created by hot melt adhesive or glue, or by a heated bar compression, or by any suitable mechanism to close the gussets through the tube at the points of the tack welds so that the center flap fold line may be created when the aforementioned folding step takes place.

FIG. 10 shows an embodiment of the result of the step of folding seen in FIG. 9, where the bottom 218 of the gusseted tube has been folded to achieve the lowercase t shape of FIG. 7, while the tube remains substantially flat. Here, the outer edge 242a of a bottom flap 224 has been pulled over and about the bottom flap fold line 238 in the preliminary folding direction 244. In so doing, the center flap fold line 232 and corresponding center flap 222, having tack welds 246 thereon, were also lifted and rotated about the other outer edge 242b and towards the bottom flap fold line 238. Thus the center flap 222 and two bottom flaps 224 are created, and the bottom of the tube may be adjusted to the lowercase t shape 220 seen in FIG. 7. Further, the gusset fold line 230 runs from the outer edges 242a, 242b of the bottom flaps 224.

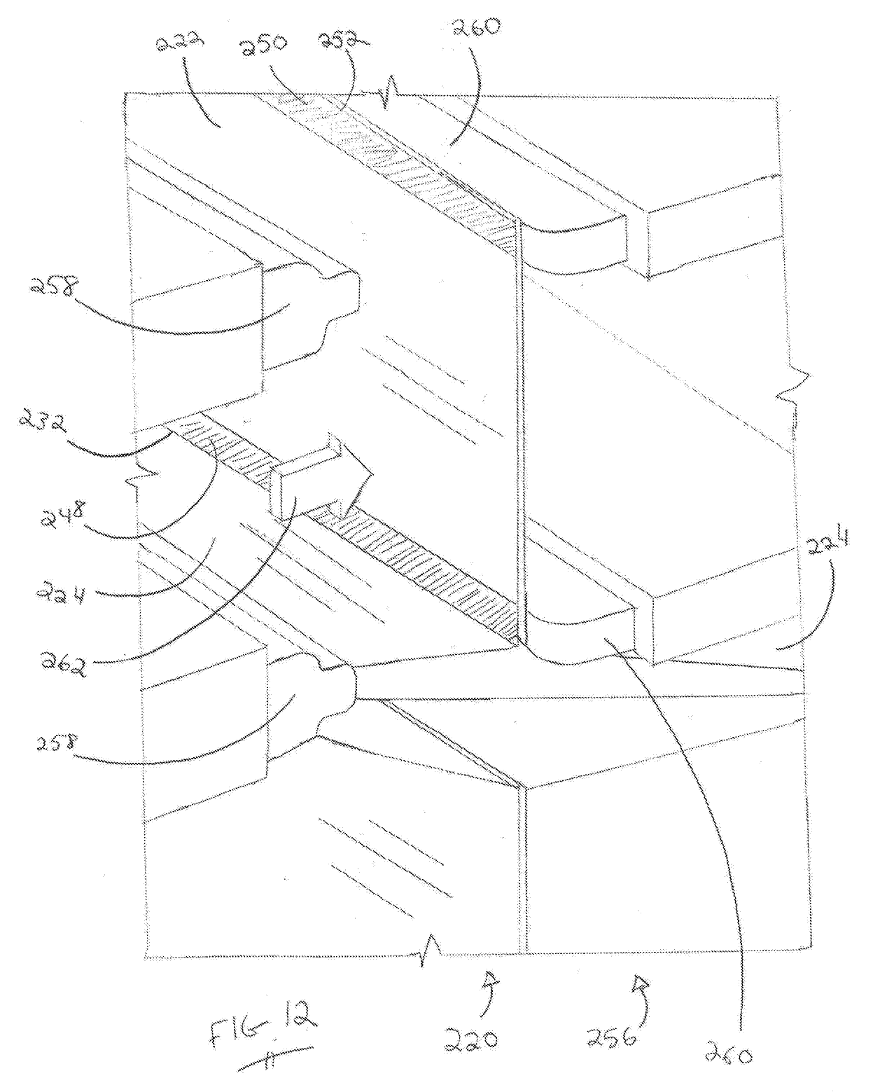

FIG. 11 shows a top down view of the folded gusseted tube of FIG. 7, traveling in a first sealing direction 234 towards one or more sealing stations. FIG. 11 further shows a pair of seals 248, 250, with one 248 on the center flap 222, abutting the center flap fold line 232, running the full width of the center flap, and the other also on the center flap 222, at the open edge 252 of the center flap, also running the full width of the center flap. These seals, when both are applied, may be applied simultaneously, or in sequence. Also seen in FIG. 11 is a center flap folding direction 254, which is the direction in which the center flap 222 will be folded about the center flap fold line 232 in subsequent steps to continue the manufacture of the bag of the disclosure.

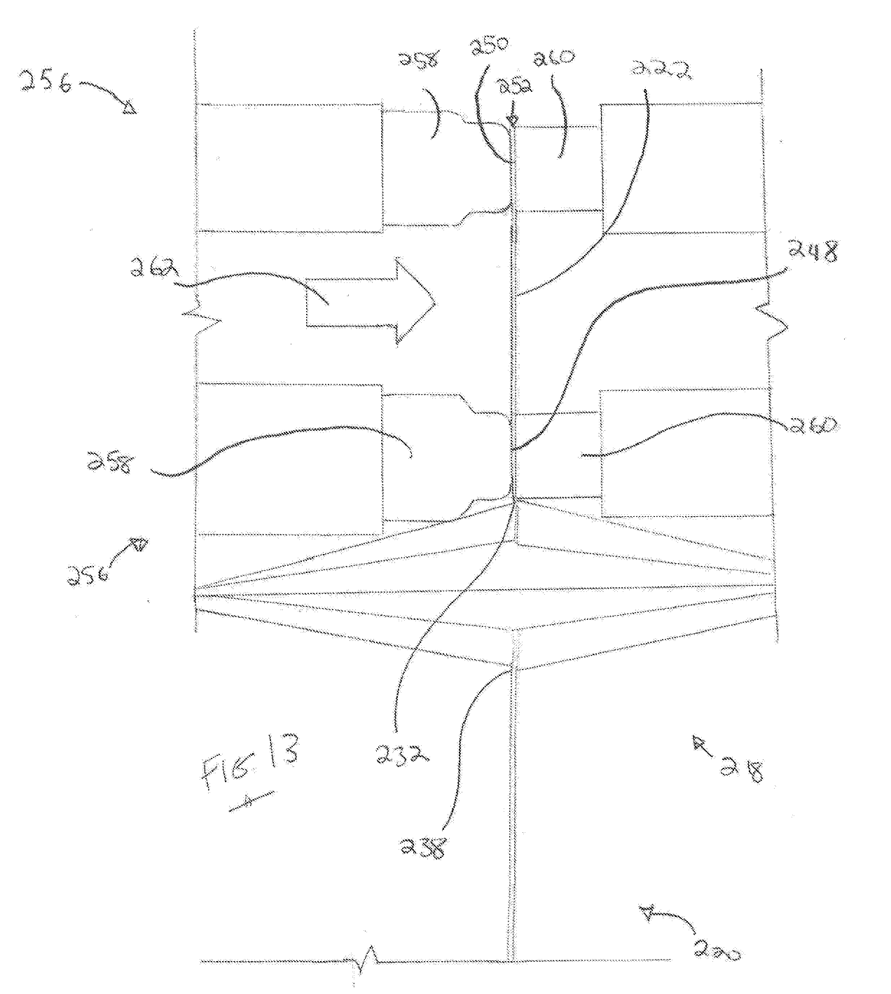

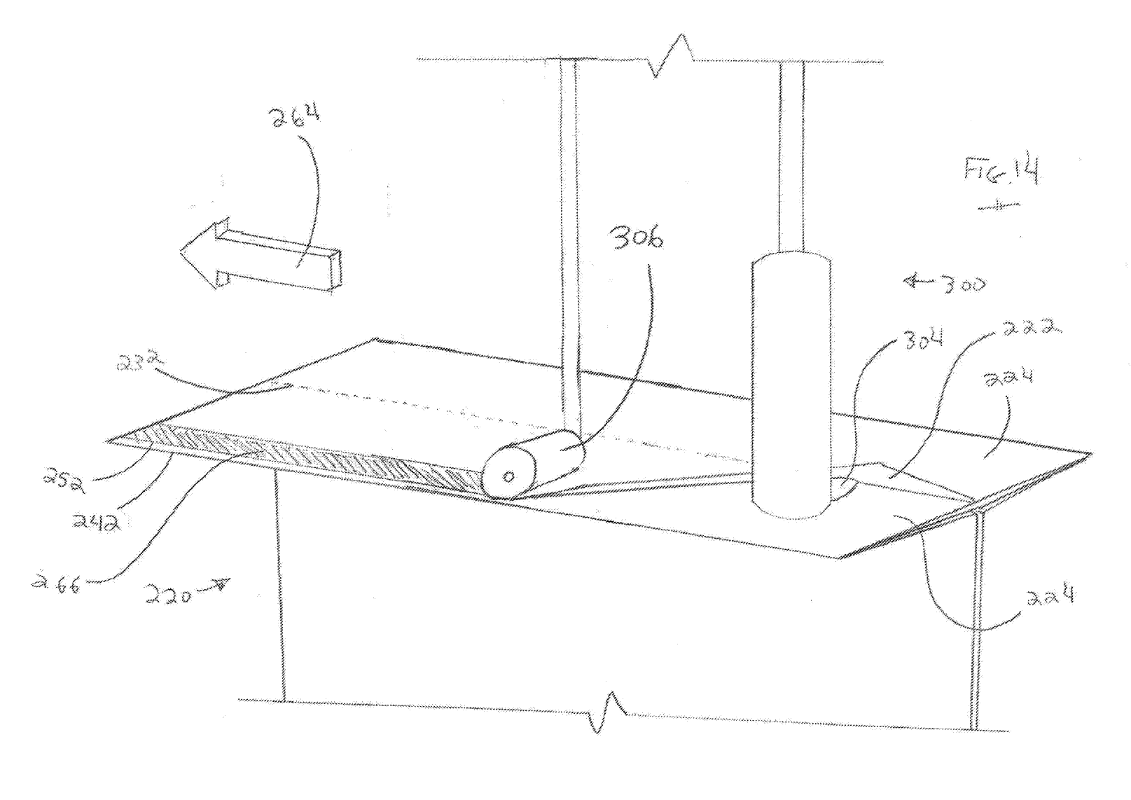

In a second step of the method of manufacturing a bag of the disclosure, one or more heat seals are applied across the width of the center flap. This step can be seen in FIGS. 12 and 13. FIG. 12 shows a partial view of an embodiment of a pair of ultrasonic welding stations 256 prepared to apply heat seals 248, 250 to the center flap 222 of the gusseted tube 220 of FIG. 11. Here, an ultrasonic weld station 256 includes a horn 258 and an anvil 260, where the center flap 222, adjacent to the center flap fold line 232 and adjacent to the open edge 252 of the center flap, are first introduced to and then may be pressed between a horn 258 and anvil 260. In this embodiment, the horns move in an ultrasonic sealing direction 258 to apply the compression. When compressed, the horn vibrates at a high frequency while steady pressure is applied across the width of the center flap 222 to create the heat seals 248, 250. The high-frequency ultrasonic acoustic vibrations to the center flap 222 to create a solid-state weld across the panels and gussets that comprise the center flap. Portions of the two heat seals are designated by areas of hashed lines in FIG. 12. FIG. 13 shows a profile view of an embodiment of a pair of ultrasonic welding stations 256 compressing in the ultrasonic sealing direction 262 onto the center flap 222 at the bottom 218 of the lowercase t or cross shaped gusseted tube 220 to create two parallel seals along the width of the center flap 222.

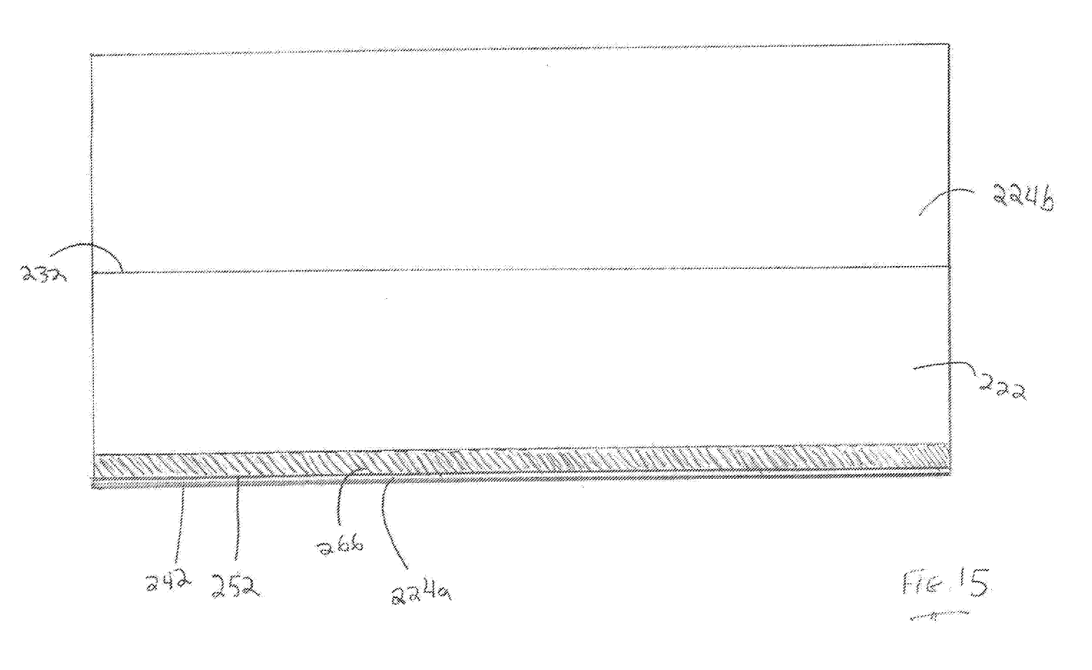

After the second step, the lowercase t shaped gusseted tube proceeds to a third step, where the center flap is folded onto a bottom flap and adhered thereto via a heat seal to complete the manufacturing process of the SOS bag of the disclosure. Turning to FIG. 14, in an embodiment the heat sealing third step of the process is implemented via a heat sealing apparatus 300, which includes a hot air nozzle 304 and a roller 306. In this third step, the center flap 222 of the tube is folded about the center flap fold line 232 onto one bottom flap 224, in conjunction with passing through a stationary heat sealing apparatus 300 and traveling in a hot air sealing direction 264. In this way the center flap 222 is adhered to a bottom flap 224 by applying hot air parallel to the width of the center flap and at the open edge 252 of the center flap, on one side of the center flap, which is then pressed against the corresponding bottom flap by a stationary roller 308 that subsequently apples pressure to center flap against the bottom flap, thereby creating a hot air seal 266. The hot air seal 266 is designated by areas of hashed lines in FIG. 14. Though rollers 308 are shown, other compression mechanisms may be used to adhere the sections of at least now partially molten plastic on the underside of the center flap to the bottom flap. Additionally, other adhesion mechanisms could be used to adhere the patch to the bottom of the tube, besides hot air sealing, including those disclosed elsewhere herein.

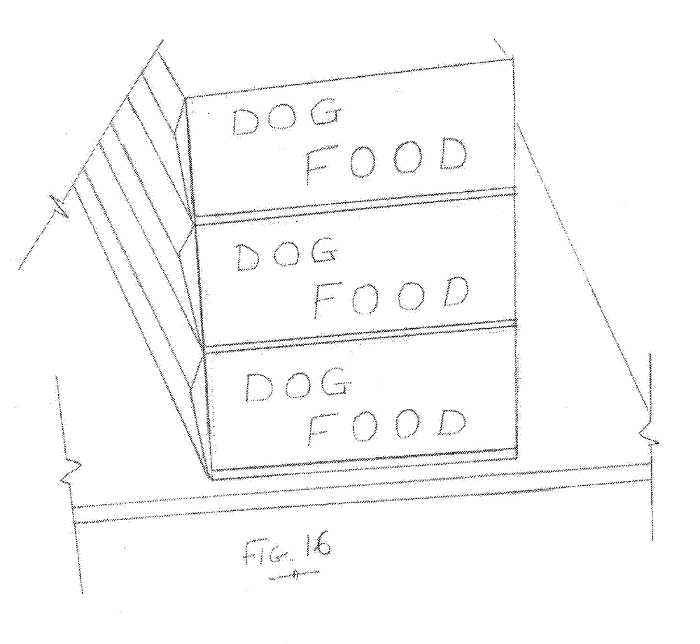

FIG. 15 shows a bottom view of an embodiment of a completed bottom of the SOS bag of the disclosure. Here, the hot air seal 266 has been applied to the center flap 222 to adhere it to a bottom flap 224a, while the other bottom flap 224b and the center flap together make a clean rectangular surface for display on the bottom of the bag. As can be seen in FIG. 15, in this embodiment the length of the center flap is slightly less than that of the bottom flap, resulting in the outer edge of the center flap 252 and the outer edge of the bottom flap 242 being parallel and in proximity, but not aligned. Bags of this process may now continue past the heat sealing mechanism to be prepared for shipment to a consumer, for example. Bags of the disclosure may be filled and stacked on shelving with the bottom flap outwardly visible towards consumers, an embodiment of which can be seen in FIG. 16.

In an embodiment, the ultrasonic weld 250 at the open edge 252 of the center flap is optional, as the heat seal 266 applied in FIG. 14 may provide sufficient closure of the open edge of the center flap without the need for that second ultrasonic seal.

Preferably the side seam of the gusseted tube is on the portion of the center flap 222 and bottom flap 224 that are folded together in FIG. 14. This permits a clean, uninterrupted surface for display on the bottom of the bag, whereas the side of the center flap with a side seam running down it could create issues with printing and appearance if the center flap was folded the other way. The side seam should be obscured by the folding of the center flap in the figures in order to provide a more suitable surface for printing on the bottom of the bag.

An SOS bag of the disclosure manufactured via the foregoing method will now resemble the prior art SOS bag of FIGS. 1 and 2, with the distinction that the bottom of the bag of the disclosure includes a unique construction manufactured via a unique method.

In an embodiment of a heat sealing mechanism of the disclosure, each heat sealing mechanism includes a nozzle for selectively applying hot air to a portion of the material and a subsequent roller to apply pressure to push two portions of material together to create the heat seal. In this mechanism, there is a direction which the material travels, while the heat sealing mechanism remains stationary, for example as one of a plurality of stations on a manufacturing line.

Where hot air heat sealing is used, the heat applied to the substrate will vary based on several factors, including the speed of manufacture in bags per minute and the material being heat sealed. The pressure required to effectuate the heat seal by pressing the at least partially molten material onto another substrate will also be determined by the speed of manufacture of the bags, the material being sealed, and the temperature of the hot air. The specific settings for the heat, speed, pressure, etc. may be calibrated on an individual basis on each machine and will vary from one machine to another, and from one process to another. Generally, though, hot air heat sealing stations may operate at a temperature range of 100 to 1,500 degrees Fahrenheit, although to make bags relatively quickly a higher range of 500 to 1,500 degrees may be preferred. Specific tolerances will vary by machine and substrate, but can typically fluctuate 25 degrees above or below the ideal conditions for bag manufacture and still make a quality product, based on a desired bag manufacturing speed. Many modern machines can manufacture bags at a rate of 60 to 80 large bags, such as those capable of holding bulky dog food, per minute, with higher end machines producing up to 100 per minute. As the speeds increase, so will the heat of the hot air and the corresponding pressure of the rollers. With bags moving faster down an assembly line, the hot air must be increased to compensate for the reduced time of exposure of the substrate to the hot air. The same may be said for any compression rollers.

Similarly, where ultrasonic welding takes place as a part of the manufacturing process, the desired speed of manufacturing of the bags will govern the vibration frequency and pressure between the horn and anvil for each bag. Where an ultrasonic station must operate more quickly, the vibration frequency and pressure may be increased. Additionally, where the substrate demands, the specific settings of the ultrasonic welding station or stations.

It will be appreciated by those of skill in the art that the various steps disclosed herein may be conducted by machinery in one or more manufacturing machines, and those machines may include a variety of tracks, wheels, rollers, and other known bag manufacturing machine components, including mechanisms to transfer the bag along the machine from beginning to end and between individual stations, such as sealing stations. Indeed, one could manufacture a bag of the disclosure at least partially by hand, escorting the gusseted tube from one station to another, such as individual sealing machines, or by making the bag of the disclosure on one or more manufacturing machines. All possible configurations of bag manufacturing machines that could be conceived by one of skill in the art that assemble a bag of the disclosure or practice the method of this disclosure are thus embraced by this disclosure, and this disclosure should not be limited to a single manufacturing machine with only the stations described herein.

The embodiment showing the length of the center flap 226 as close to, but not at, the length of the bottom flaps 224, as seen in FIG. 7 and later in FIG. 15, is in part due to the nature of the material from which the gusseted tube may be constructed. Plastic film, by its nature, has memory as a property. By memory, it is understood that plastic film wants to return to its original planar structure and doesn't provide the crisp, clean ninety degree folds that a paper material, for example, might provide. So where the gusseted bag is constructed of a substantially plastic material, such as for example an effectively single ply constructed by laminating an inner woven oriented polypropylene layer with a reverse printed oriented polypropylene film layer, long folds of this material will not have totally crisp ninety degree folds that retain their shape at the same level as a paper bag, such as the brown paper lunch sack discussed earlier herein. Because plastic has memory, the various folds of the gusseted tube and additionally the finished product gusseted SOS bag of the disclosure will not be sharp bends, but rather very subtle curves at the folds. Even after folding along a crease, the plastic material will try, even if only slightly so, to curve back into a plane. When center flap about the center flap fold line and sealing it to complete the bottom of the bag, having the uppermost edge of the center flap flush with outer edge of the bottom flap might not result in as effective of a seal because of the memory of the plastic at those bends into the bottom of the bag. The edge of the center flap in that instance might not adhere to the rest of the bottom of the bag while the folded plastic is attempting to return to a planar shape. Instead, by having the center flap be near, but not at, the length of the bottom flap, the outer edge of the center flap that are intended for display may be tightly sealed against the bottom of the bag, resulting in a more complete seal. Ideally, in order to achieve the largest display area possible, one would like to have the edge of the center flap align with the edge of the bottom flap, but plastic memory prevents this level of efficiency.

Thus a method of manufacturing a new SOS type bag has been disclosed, including the preliminary step of providing a gusseted tube of indefinite length. In a first step, the tube is folded to create a lowercase t or cross shape at the bottom of the tube, when the tube is viewed in profile from a gusset side of the tube. The result of this first step is the creation of a center flap, and two bottom flaps, which together with the remainder of the tube create the lowercase t or cross shape of the figures. In a second step, one or more heat seals are applied across the width of the center flap. In a third step, the center flap is folded onto a bottom flap and sealed thereto to complete the construction of the bag.

A new flat bottomed gusseted SOS bag has also been disclosed. Bags of the disclosure may include a gusseted bag having a front and back panel joined by gussets, where the bottom of the SOS bag includes a pair of inwardly folded gussets to create a pair of bottom flaps and a center flap, where the center flap is folded over one bottom flap to create a flat folded bottom. A series of heat seals may be applied to the center flap to seal it against the interior of the bag, as well as at least one heat seal to adhere the center flap to a bottom flap to create a substantially complete seal to the bottom of the bag. The center flap and bottom flap onto which it is folded may be complementary in shape, and the center flap may be slightly less in length than the corresponding bottom flap. The top of the bag may contain any type of suitable closure or reclosure mechanisms known in the art, and the top of the bag may be open or closed, and may include a flush cut, step cut, or Z cut. Bags of the disclosure may be constructed of a variety of materials, including a colaminated effectively single ply of woven oriented polypropylene and reverse printed oriented polypropylene, or other various constructions known in the art. Bags of the disclosure may include printing on the bottom of the bag, on the patch of the bag, to provide a legible display for consumers.

Bags of the disclosure provide several advantages over conventional bags of the prior art. For example, in the packaging of pet food, bags of the disclosure have various specific benefits. Pet food, including dry dog food, can be a greasy and heavy product. In the past, the packaging industry had embraced the use of paper-based or paper composite bags for dog food. However, at as the size of the bag, and thus the weight and volume of the dog food contained therein, increased, consumers and retailers were met with more frequent failures of the bag integrity, resulting in loss of product, mess in the retail environment, and negative consumer experiences.

As the industry shifted away from paper-based bag construction, woven oriented polypropylene became more favored, due to its substantially improved strength, particularly its resistance to puncture. Dog food became increasingly stored in bags constructed of a ply of woven oriented polypropylene (OPP) laminated with a layer of reverse printed plastic film, with the woven OPP on the inside of the bag against the food. These bags, by virtue of the construction material, in some instances provided less flexibility and less opportunity for attractive printing. Many of these large woven OPP were rolled and heat sealed on the bottom, which did not provide an attractive or particularly useful area for the dog food company to print. Large, heavy bags of pet food (or other goods) tend to lay on their sides in a retail environment, giving increased value to the bottom of the bags for printing.

Bags of the present disclosure, however, attempt to overcome the failures of the art. Bags disclosed herein allow the printing of logos and other information to attract consumers on the bottom of the bag in a clean, consistent manner on a substantially congruent surface. Bags can be stored laying down with the bottom-out and facing consumers, allowing for more product to be stored on shelves. Additionally, the rectangular bottoms of the bags, paired with the gusseted shape of a traditional SOS bag body, will allow tighter stacking of bags of product, both on top of each other and in adjacent columns of product. These and other advantages associated with the bags of the present disclosure will be apparent to those of ordinary skill in the art.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention as well as all equivalents thereof.

We claim:

1. A method of manufacturing a gusseted bag comprising the steps of
first providing a gusseted tube of material of indefinite length, the tube comprising a front panel and a back panel joined by two gussets and having an interior cavity and a top and a bottom, wherein the front panel, rear panel, and gussets each has respective bottom edges at the bottom of the tube, and
in a second step, folding the bottom of the tube to create a lowercase t shaped gusseted tube, wherein this second step comprises the steps of (a) having the gusseted tube in a substantially flat folded positions, (b) applying a pair of tack welds to the tube at their outer edges of the tube and gussets at a center flap fold line, (c) pulling a portion of the tube at an outer edge of an outer flap in a folding direction over and about a bottom flap fold line, this second step, wherein this second step creates a center flap and two bottom flaps,
in a third step, passing the gusseted tube in a sealing direction and sealing the center flap across its width,
in a fourth step, passing the gusseted tube in a sealing direction and folding the center flap onto a bottom flap and sealing the center flap thereto.
